(19) United States
(12) Patent Application Publication
(10) Pub. No.: US 2007/0196020 A1
(43) Pub. Date: Aug. 23, 2007

(54) Registering Objects

(75) Inventor: Daniel Fasulo, Titusville, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH INC, PRINCETON, NJ (US)

(21) Appl. No.: 11/467,219

(22) Filed: Aug. 25, 2006

Related U.S. Application Data
(60) Provisional application No. 60/712,962, filed on Aug. 31, 2005.

(51) Int. Cl. G06K 9/62

(52) U.S. Cl. 382/225

(57) ABSTRACT

A computer-implemented method for registering objects of interest across a plurality of data acquisition types includes providing image data including the objects of interest corresponding to the plurality of data acquisition types, providing a plurality of constraints on groups which may be determined for the objects of interests determining a set of possible groupings of the objects of interest according to the plurality of constraints, searching the set of possible groupings for groupings of the objects of interest according to an optimization function, and storing the groupings of the objects of interest to a computer-readable media.

This application claims the benefit of Provisional Application No. 60/712,962 filed on Aug. 31, 2005 in the United States Patent and Trademark Office, the contents of which are herein incorporated by reference in its entirety.

### BACKGROUND OF THE INVENTION

1. Field of the Invention

The present disclosure relates to image processing, and more particularly to a system and method for registering objects.

2. Description of Related Art

Referring to the process of aligning data from liquid chromatography and mass spectrometry (LC-MS) and 2D electrophoretic gel (2DE) experiments, in 2DE, proteins form a set of “spots” on a gel. Software is used identify and quantify the spots, giving is each spot a characteristic mass, isoelectric point, and intensity. This is analogous to the mass-charge ratio, retention time, and intensity values found in LC-MS maps. Popular packages for comparing the sets of spots between 2DE gels include Flicker, CAROL, Delta2D (a product of Decodon GmbH), and Melanie. The exact comparison mechanism differs in each package, but these software packages are designed for pairwise comparisons of gel images. Typically, the user is expected to compare a new gel to a reference database of 2DE gels.

There has been related algorithmic work conducted in the two-dimensional case, where the bounded error model yields rectangles, which may be used in building rectangle overlap graphs.

The clique building approach in two dimensions requires that all maximal cliques of a rectangle overlap graph be found. This problem has been addressed by a number of authors in the statistical estimation literature, where finding all maximal cliques in a rectangle overlap graph is a subproblem for maximum likelihood estimation with respect to bivariate interval censored data. The algorithms from the literature fall into two categories, those that merely describe the rectangular regions of mutual overlap defined by the maximal cliques (type I), and those that explicitly compute each rectangle's membership in the maximal cliques (type II).

An exemplary type I algorithm finds the rectangular regions defined by the maximal cliques in O(n²) time. This result is one in a line of proposed solutions, where others have implemented a type I algorithm in O(n³) time and O(n⁵) time, and a type II algorithm in O(n⁵) time.

General clustering algorithms are usually not suited to the bounded error model of data alignment. Some require prior knowledge of the total number of objects, which is not available to us. Others require various other parameters whose selection is less obvious than the error bounds derived from the sensors.

Therefore, a need exists for a system and method for registering objects.

### SUMMARY OF THE INVENTION

According to an embodiment of the present disclosure, a computer-implemented method for registering objects of interest across a plurality of data acquisition types includes providing image data including the objects of interest corresponding to the plurality of data acquisition types, providing a plurality of constraints on groups which may be determined for the objects of interest, determining a set of possible groupings of the objects of interest according to the plurality of constraints, searching the set of possible groupings for groupings of the objects of interest according to an optimization function, and storing the groupings of the objects of interest to a computer-readable media.

The plurality of constraints are error bounds on sensor data corresponding to a detection of each of the objects of interest. Determining the set of possible groupings of the objects of interest is performed according to a bounded error model of the error bounds corresponding to the objects of interest. Searching determines which grouping from the set of possible groupings best satisfies the optimization function.

Providing the plurality of constraints on groups comprises converting a plurality of features of the image into boxes in d-dimensional space, wherein d is greater than 2, and wherein the plurality of constraints are implemented as a box for each feature, the box representing error bounds on sensor data corresponding to a detection of the features. Determining the set of possible groupings of the objects of interest according to the plurality of constraints comprises determining a set of mutually-intersecting boxes.

According to an embodiment of the present disclosure, a computer-implemented method for registering objects of interest across a plurality of data acquisition types includes inputting image data including features, the image data including inputs corresponding to the plurality of data acquisition types, providing a plurality of constraints on groups which may be determined for the features, determining a set of possible groupings of the features according to the plurality of constraints, searching the set of possible groupings for groupings of objects of interest according to an optimization function, wherein the set of possible groupings includes groupings of the objects of interest and groupings of features that do not correspond to the objects of interest, and storing the Groupings of the objects of interest to a computer-readable media.

Providing the plurality of constraints on groups comprises converting the features into boxes in 4-dimensional space, wherein d is greater than 2, and wherein the plurality of constraints are implemented as a box for each feature, the box representing error bounds on sensor data corresponding to a detection of the features. Determining the set of possible groupings of the features is performed according to a set of mutually-intersecting boxes of the features.

Searching determines and removes groupings violating transitivity.

According to an embodiment of the present disclosure, a program storage device is provided readable by machine, tangibly embodying a program of instructions executable by the machine to perform method steps for registering objects of interest across a plurality of data acquisition types. The method steps include providing image data including the objects of interest corresponding to the plurality of data acquisition types, providing a plurality of constraints on groups which may be determined for the objects of interest, determining a set of possible groupings of the objects of interest according to the plurality of constraints, searching the set of possible groupings for groupings of the objects of interest according to an optimization function, and storing the groupings of the objects of interest to a computer-readable media.

### BRIEF DESCRIPTION OF THE DRAWINGS

Preferred embodiments of the present invention will be described below in more detail, with reference to the accompanying drawings:

FIG. 1 is a flow chart of a method for registering objects, according to an embodiment of the present disclosure;

FIG. 2 is a flow chart of a method for enumerating all maximal sets of mutually-intersecting boxes, according to an embodiment of the present disclosure;

FIG. 3 is a diagram of a system according to an embodiment of the present disclosure

### DETAILED DESCRIPTION OF PREFERRED EMBODIMENTS

According to an embodiment of the present disclosure, a method registers objects of interest across multiple data acquisitions. The method has features of a clustering algorithm and is specialized for data that fits a certain model of uncertainty. Constraints are placed on the way in which objects can be grouped. The method finds a set of possible groupings, which obey the constraints, and searches only over the restricted set of solutions.

According to an embodiment of the present disclosure, a model assumes that the attributes of the objects are being measured by imperfect sensors making stochastic errors, and that the objects are static and otherwise anonymous. Each attribute is represented as a real number with an error bar placed around it. Objects can be considered identical if and only if their attributes are approximately the same, as defined by the intersection of respective error bars.

Under this model, an acquisition is a set of sensor measurements on a set of objects. The observations from the acquisitions are organized into sets corresponding to the same object under simplifying assumption that two objects that may be identical based on sensor observations are identical in the absence of ambiguity or other evidence to the contrary.

According to an embodiment of the present disclosure, a system and/or method includes components including a module/method to efficiently find all maximal sets of potentially identical objects; a framework to resolve the ambiguous cases that arise in these sets, such as when an object appears in more than one set; and a module/method to heuristically help the user select the error bounds under certain assumptions.

The method implements a paradigm for registering objects of interest across multiple data acquisitions. The paradigm is a clustering method specialized to a data model with certain underlying assumptions.

In general, clustering algorithms partition a set of objects into groups based on a notion of similarity. These groups are supposed to contain objects that are “closely related”, a phrase whose formal definition varies depending on the method. The clustering algorithm produces these groups by an implicit or explicit optimization method. Further, according to an embodiment of the present disclosure, hard constraints are placed on the way in which objects can be grouped. These constraints are designed so that the method can efficiently describe all possible solutions that obey the constraints. An optimization method is used to select a best solution. The number of possible solutions under the constraints is typically smaller than all possible partitions of the data, making the method fast for many large problems and allowing more costly optimization schemes for the constrained optimization phase of the method.

Hence, systems and methods are described in terms of experiments, which measure properties of anonymous objects, for determining, based solely on the measurements, which objects are identical across the set of experiments.

The Model

In the model, an object refers to a physical object to be observed in some experiments. Let U={O₁,O₂, . . . ,O_{M}} denote the universe of objects of interest in the experiments. The experiments have the effect of observing the objects through a set of d sensors.

It is assumed that the experiments are processed independently through an imperfect method to detect the objects. Let ε={E₁,E₂, . . . ,E_{K}} be the set of K experiments. Each experiment Eₖ is itself a set of features, denoted fₖ⁽ⁱ⁾ where 1≦i≦|Eₖ|, that have been detected and are believed to correspond to objects. However, this correspondence is not necessarily one-to-one. Some features may be spurious (false positives) and do not correspond to real objects; in other cases no feature is detected corresponding to a particular object in an experiment. This may either be due to a false negative, or the object being absent in that particular experiment. In the case where the feature fₖ⁽ⁱ⁾ does correspond to an object Oₘ, we define π(fₖ⁽ⁱ⁾)={Oₘ}; otherwise, π(fₖ⁽ⁱ⁾=Ø.

Further, the features are modeled as being subject to stochastic noise. Each feature fₖ⁽ⁱ⁾ is represented as a vector in [symbol] ^{d}, whose entries correspond to readings from the d sensors. The reading from sensor j is denoted fₖ⁽ⁱ⁾[j], and is assumed to be subject to both the inherent inaccuracy of the sensor and the imprecision of the feature construction method.

Instead of modeling this inaccuracy directly, for example, by imposing some distribution upon it, the following hard constraint is imposed. Let εⱼ: [symbol] →{ [symbol] } be an error bound on the features in dimension j. More specifically, εⱼ maps a feature f to an interval [εⱼ^{l}(f[i]),εⱼ^{τ}(f[j])]. Typically, f[j]εεⱼ(f[j]), although this is not technically needed.

Axiom 1 (Bounded Measurement Error). For all features f₁,f₂ε∪ₖ₌1^{K}Eₖ such that π(f₁)∩π(f₂)≠Ø and for all j, 1≦j≦d we can select j such that εⱼ(f₁[j])∩εⱼ(f₂[j])≠Ø.

The error bounds form intervals on the real number line contain each sensor measurement. For two features to be observations of the same object, the interval associated with each corresponding sensor measurement must intersect. Two features which satisfy these constraints are said to be compatible.

Example. Suppose that a device measures the mass of a molecule with an accuracy of ±1%. In one experiment, the molecule is observed to have a mass of 1000 AMU. Its actual mass must then lie in the interval [990.1, 1010.1] since 990.1+0.01(990.1)=1000 and 1010.1−0.01(1010.1) 1000.

Now suppose that a molecule with a mass of 998 were observed in a subsequent experiment. Under the same model, the true mass of the second molecule would lie in the interval [988.1, 1008.1]. The intersection of the intervals for the two observations is [990.1, 1008.1], meaning that a molecule in this mass range could explain both observations and hence the features are compatible.

Note that this example demonstrates a feature of the model: the objects and features are anonymous; there is no way to know for certain, within the context of the model, whether two features are truly observations of the same entity. Instead, the model simply provides a definition under which two features are potentially the same. Attempting to determine which features are the same given the features' anonymity requires solving a potentially complex optimization problem. However, assuming that compatibility implies identity allows for substantially reducing the search space for this optimization problem.

There are cases in which features are compatible under the model and yet may not be considered identical. One involves violations of transitivity, a property that must hold for an identity relationship. If features f₁ and f₂ are compatible and features f₂ and f₃ are compatible, then there are two possibilities: either f₁ and f₃ are compatible, in which case all three features may be considered identical, or at least one of π(f₁)∩π(f₂)=Ø and π(f₂)∩π(f₃)=Ø holds. Another case in which compatible features may not be identical occurs when features f₁ and f₂ are compatible, but both f₁ and f₂ derive from the same experiment Eₖ. How this case is handled is application-dependent; the experiment may or may not be able to make multiple observations of the same object.

Approach

Based on the model above, it is assumed that a set of K experiments are given, each being a set of features. Each feature, in turn, is a vector of d numbers. Given this, the set of all features may be partitioned into subsets that correspond to the same underlying object. No interest is taken in those features that do not correspond to objects, as long as they do not end up in sets with features that do correspond to objects.

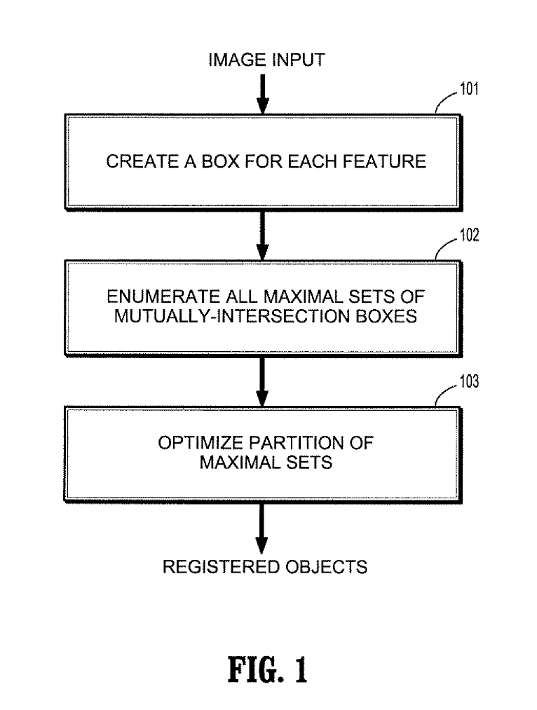

Referring to FIG. 1, partitioning includes the following, described in more detail in the subsequent sections:
Create a box for each feature by constructing the constraint intervals in each of the d dimensions (recall that a box is a Cartesian product of intervals). In the case where there is little or no a priori information on the appropriate interval widths, a heuristic approach to selecting good bounds is presented in below under the title Estimating the Error Bounds (101).
Use the algorithm described below under the title A Fast Method for Finding All Maximal Mutually-Intersecting Sets of Boxes in d-dimensional Space to enumerate all maximal sets of mutually-intersecting boxes (102).
These sets satisfy the constraint of Axiom 1, but they do not completely solve the problem of partitioning the input into sets of identical objects. Violations of transitivity cause features to appear in multiple sets; additionally, features from the same set may not be identical when other evidence is examined. Under the title The Constrained Optimization problem, the formation of the final partition is placed into the context of an optimization problem (103). An effective way to solve this problem is application-dependent.

Applications

In summary, the model and approach (described subsequently) apply at least to problems with the following features:
The objects are anonymous and the number of objects is large.
The objects are observed by a modest number of methods which produce numerical measurements in a metric space with some bounded error.
The objects are static with respect to the measurements being taken across all experiments.
Errors in the data take the form of stochastic error in the measurements, detection of features which are not actual objects (false positives), and failure to detect features corresponding to objects that should be present (false negatives).
The size of each group is expected to be small relative to the total number of input features, although there may be a large number of groups.

It is worth pointing out some common tasks which do not fit the model without some modification or preprocessing. These include data in which the sensor error is biased (for example, due to miscalibration of an instrument), data in which the objects' properties change from experiment to experiment (for example, tracking moving objects; the position is changing), data in which the feature attributes are not metric, and data in which the feature attributes are not independent and/or must be considered in combination when determining similarity.

A Fast Method for Finding All Maximal Mutually-Intersecting Sets of Boxes in d-Dimensional Space

This section addresses the problem of finding all maximal sets of mutually compatible features. Assuming that the error function j, 1≦j≦d, has been chosen for all sensors, so that the features are converted into boxes in d-dimensional space. Also, note that if a feature is missing a particular sensor observation, it can be assigned an interval which spans the space of observations.

Problem Statement

Let B be a set of n iso-boxes in [symbol] ^{d}. Each box BᵢεB can be represented as a set of d non-empty intervals, each denoted Xⱼ(Bᵢ), 1≦j≦d, and called the extent of Bᵢ in dimension j. Adopting the convention that each interval is closed on the left and right, and notation so that Xⱼ(Bᵢ)=[xⱼ^{l}(Bᵢ),xⱼ^{τ}(Bᵢ)]. When a discussion centers on a particular box, the Bᵢ may be omitted and the notation Xⱼ may be used for the extent in dimension j and [xⱼ^{l},xⱼ^{r}] as the corresponding interval.

For clarity of presentation, we impose the condition that there be a unique ordering of all interval end points in each dimension. In other words, for each dimension j, there cannot be distinct boxes B and B′ such that xⱼ^{l}(B)=xⱼ^{l}(B′), xⱼ^{r}(B)=xⱼ^{r}(B′), or xⱼ^{l}(B)=xⱼ^{r}(B′). This condition is no burden in practice, because a consistent scheme of handling ties can easily he devised.

The term clique is used to refer to a set of mutually intersecting boxes. That is, if C={B₁,B₂, . . . ,Bₘ} is a clique, then ∀j, 1≦j≦d, ∩ᵢ₌1^{m}Xⱼ(Bᵢ)≠Ø. The implication is that each clique has an area of intersection in [symbol] ^{d} which is itself a box. The box is possibly degenerate in one or more dimensions, but this has no practical effect on our method. We denote the area of intersection for clique C as box A_{C} and borrow corresponding notation to say that the extent of A_{C} in dimension j is Xⱼ(A_{C}), where

$${X}_{j} ( {A}_{C} ) = [ {x}_{j}^{ℓ} ( {A}_{C} ) , {x}_{j}^{r} ( {A}_{C} ) ] = {⋂}_{B ∈ C} {X}_{j} ( B )$$

It is also worth noting that for each dimension

$$j , {X}_{j} ( {A}_{C} ) = [ {x}_{j}^{ℓ} ( {A}_{C} ) , {x}_{j}^{r} ( {A}_{C} ) ] = {⋂}_{B ∈ C} {X}_{j} ( B )$$

and xⱼ^{r}(A_{C})=min_{BεC}xⱼ^{r}(B).

A clique C is maximal if and only if there does not exist a box Bεβ−C such that C∪{B} is a clique. Given the set β, it is possible to explicitly find all maximal cliques occurring in β.

Solution

Let G(β) be an undirected graph such that there is a vertex corresponding to each box in β and an edge between every pair of intersecting boxes. Such a graph is called the box intersection graph, and there is an obvious correspondence between the maximal cliques in this graph and the maximal cliques defined in our problem statement. However, no attempt is made to explicitly create G(β) and pursue a graph-theoretic approach to finding the cliques; instead, an approach based on computational geometry is used.

For all d>1, the slice operator on box B at x, S^{d}(B,x), is defined as the projection of B into [symbol] ^{d-1} obtained by dropping X_{d} if xεX_{d}, or Ø otherwise. More formally, let B′ be a box in [symbol] ^{d-1} where ∀j, 1≦j≦d−1, Xⱼ(B′)=Xⱼ(B). Let xε [symbol] , and define S^{d}(B,x)=B′ if xεX_{d}, or Ø otherwise.

The slice set of box Bᵢ, Sᵢ^{d}, may be defined as follows:
Sᵢ^{d}s={S^{d}(Bⱼ,x_{d}^{r}(Bᵢ)):S^{d}(Bⱼ,x_{d}^{r}(Bᵢ))≠Ø,1≦j≦n}
Informally, Sᵢ^{d} is the set of boxes in β which intersect the hyperplane in [symbol] ^{d} normal to dimension d at x_{d}^{r}(Bᵢ), projected down onto that hyperplane. The effect of the projection is to eliminate dimension d.

Using the slice set concept and a small set of lemmas to propose a recursive method for finding the maximal cliques of β; the recursion proceeds on the number of dimensions, and the base case is reached when d=1 (or, optionally, when d=2). Later, a direct, efficient method for the case where d=1 and reference another for the case where d=2 are given.

Lemma 1. Let C be a maximal clique of G(β). Then C is a maximal clique of G(Sᵢ^{d}) for some BᵢεC.

Proof: Let BᵢεC be the box with minimum x_{d}^{r}(Bᵢ). Since C is a clique, it must be the case that for all BεC, x_{d}^{l}(B)<x_{d}^{r}(Bᵢ). Furthermore, by definition, x_{d}^{l}(B)≧x_{d}^{r}(Bᵢ). Therefore, all elements of C occur in Sᵢ. It is easy to see that by the definition of a clique, all elements of a clique in [symbol] ^{d} must form a clique in their first d−1 dimensions; hence, the elements of C form a clique in Sᵢ^{d}. C needs to be maximal with respect to Sᵢ^{d}. If there were some other box B′ that were in Sᵢ^{d} and could be added to C, then this rectangle would also intersect all rectangles in dimension d at x_{d}^{r}(B) and hence C would not be maximal in G(β).

For convenience, the set of maximal cliques of G(β) are denoted as C, and the set of maximal cliques in G(Sᵢ^{d}) that contain Bᵢ as Cₗ^{d}. The consequence of Lemma 1, stated succinctly as C⊂∪ⱼ₌₁ⁿCₗ^{d}, shows how to proceed toward finding the maximal cliques of β:C

Step 1. If d=1, calculate the maximal cliques of β directly.

Step 2. Otherwise, calculate each Sᵢ^{d} and recursively find the corresponding Cₗ^{d}.

Step 3. Filter out those elements of Cₗ^{d} which are not maximal with respect to G(β).

Referring to Step 1, an exemplary algorithm is given above with respect to finding cliques in one dimension. Since each Sᵢ^{d} is simply a set of boxes in [symbol] ^{d-1}, Step 2 is a straightforward recursive usage of the algorithm. The subtle catch is that only those cliques containing Bᵢ are retained for Step 3. Conceptually this can be accomplished by simple post-proccssing of the result of the recursive application, although an implementation that does not construct cliques that do not contain Bᵢ in the first place will be more efficient.

The remainder of this section on Step 3. Step 3 depends on the construction and processing of the slice sets in a particular order. Let Pd be the set of all interval end points in dimension d; that is, P_{d}=∪ᵢ₌₁ⁿ{x_{d}^{l}(Bᵢ),x_{d}^{r}(Bᵢ)}. Let \vec{P}_{d} be a vector of length 2n containing the elements of P_{d} sorted in increasing order, recalling that for simplicity we assume that all elements of P_{d} are unique.

Let L be a data structure representing a set of boxes. The data structure must support fast insertion and deletion of elements, and enumeration of all elements of the set in O(|L|) time. Examples of such a data structure would be a balanced binary tree or hash table that uses the index i of each Bᵢ as a key.

The slice sets are enumerated by considering each member x of \vec{P}_{d} in increasing order. There are two cases for each x: either x=x_{d}^{l}(Bᵢ) or x=x_{d}^{r}(Bᵢ) for some Bᵢεβ, meaning that either x is the start of Bᵢ in a left-to-right sweep of dimension d, or the end. Suppose x is the start of Bᵢ. In this case, Bᵢ is inserted into L. If x is the end Bᵢ, then L contains exactly those intervals in S d i. Sᵢ^{d} is extracted, Bᵢ is removed from L, and Sᵢ^{d} recursively processed to generate Cₗ^{d}. The following lemma demonstrates why it is useful to generate and process the slice sets in this order.

Lemma 2. Let CεCⱼ^{d} be a maximal clique of G(Sⱼ^{d}) that is not maximal with respect to G(β). Then there exists a clique CεCᵢ^{d} with x_{d}^{r}(Bᵢ)<x_{d}^{r}(Bⱼ) such that C′⊂C.

Proof: By Lemma 1, a maximal clique C of G(β) that contains C′ must be contained in some Cᵢ^{d}. Suppose that x_{d}^{r}(Bᵢ)>x_{d}^{r}(Bⱼ). By definition Bⱼε′, but Bⱼ∉C′ because S^{d}(Bⱼ,x_{d}^{r}(Bᵢ)) must be Ø. The implication is that C′⊂C. Hence, it must be the case that x_{d}^{r}(Bᵢ)<x_{d}^{r}(Bⱼ).

Thus, as long as the cliques are considered in increasing order of x_{d}^{r}, it can be guaranteed that all cliques found in the slice sets that are not maximal with respect to G(β) will be observed after their containing maximal clique. Testing for clique containment is accomplished via the computational geometry result of the next lemma.

Lemma 3. Let CεC be a maximal clique of G(β). The clique C′⊂C if and only if A_{C}⊂A_{C}.

Proof: Suppose first that C′⊂C. It follows immediately from the comments in Section 2.1 on areas of intersection that A_{C}⊂A_{C}. Therefore, the centroid of A_{C} is contained in A_{C}.

Conversely, suppose that A_{C}⊂A_{C′} and let x be an arbitrary point such that x□AC. This implies xεA_{C′}, so all of the rectangles of C′ must also contain x. Hence all rectangles in C and C′ share a common point of intersection, so the set C′=C∪C′ is a clique. Since C is maximal, this means that C″⊂C′, and hence C′⊂C.

Thus, in order to test if C′ is a sub-clique of a previously-observed clique C, it can be tested to see if A_{C}⊂A_{C′}. Another scheme may be considered as: an arbitrary point x can be selected from each clique C as it is output (in practice, the centroid x̅ of A_{C} may be used). This creates a set of points X̅. When then considering a subsequently-detected clique C′, it has been observed that C′ is maximal if and only if X̅∩A_{C′}=Ø. Hence, the method need only test if some point in X̅ is contained in a box A_{C′}, a problem for which a number of efficient solutions exist.

Finding Cliques in One Dimension

The base case for the d-dimensional problem is achieved when d=1, although there is a direct solution for d=2 that may perform better than the recursive algorithm when d=2.

An algorithm for the one-dimensional case is summarized here for completeness. Let 1 be a set of n intervals in [symbol] . For each Iᵢε1, let Iᵢ=[x^{l}(lᵢ),x^{r}(lᵢ)]. As before, for simplicity of presentation we assume all of the interval end points are unique. Let P be the set of all interval end points; that is, P=∪ᵢ₌₁ⁿ{x^{l}(lᵢ),x^{r}(lᵢ)}. Let \vec{P} be a vector of length 2n containing the elements of P sorted in increasing order, recalling that for simplicity we assume that all elements of P are unique. Let p(i)=l if P[i]=x^{l}(lᵢ) for some j; otherwise p(i)=r because it must be the case that \vec{P}[i]=x^{r}(lⱼ) for some j.

Let Sᵢ denote the set of intervals containing the point \vec{P}[i]. For completeness, define p(0)=r.

Theorem 1. Si is a maximal clique of intervals if and only if p(i)=r and p(i−1)=l.

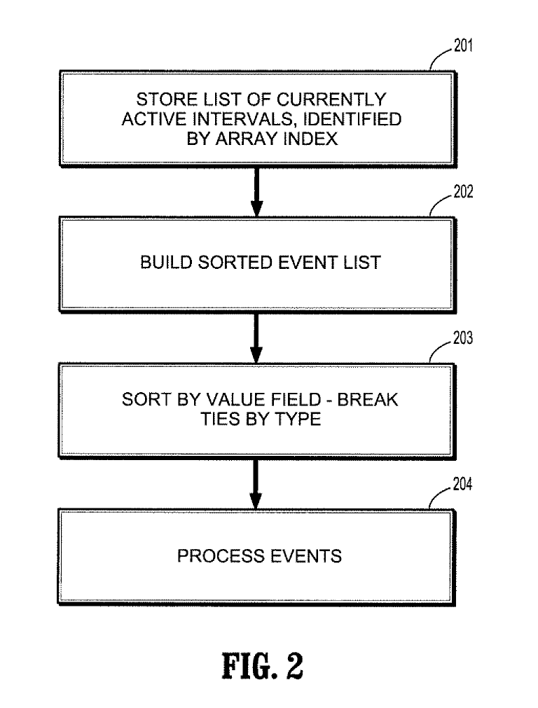

A sweepline procedure built around Theorem 1 appears in FIG. 2 and the pseudo code below. The method marks the sweepline as “live” when the previous event was a left end point, and marks it as “dead” when the event was a right end point. Output of a clique occurs only when the sweepline transitions from “live” to “dead”.

function find_cliques_ld(ia: Array of Interval): List of Clique

| result : List of Clique; | |
|---|---|
| event : Array of Event; | |
| i : Integer; | |
| sweep : List of Integer; | /* Stores list of currently active intervals, |

identified by array index (201) */

sweep_status : Enum { LIVE, DEAD };

/* Build sorted event list (202) */

for i := 1 to size(ia) do

event[2 * i − 1].type := BEGIN;
event[2 * i − 1].value := left(ia[i]);
event[2 * i − 1].id := i;
event[2 * i].type := END;
event[2 * i].value := right(ia[i]);
event[2 * i].id := i;

| end for | |
|---|---|
| sort(event); | /* By value field. Ties are broken by type, |

with BEGIN first. (203) */

/* Process events (204) */
sweep_status := LIVE;
for i := 1 to size(event) do

if (event[i].type = BEGIN) then

insert(sweep, event[i].id);
sweep_status := LIVE;

else /* type = END */

if (sweep_status = LIVE) then

insert(result, make_clique(sweep));
sweep_status := DEAD;

end if
remove(sweep, event[i].id);

end if

end for
return result;

end

Pseudo-code for one-dimensional algorithm (see FIG. 2).

The Constrained Optimization Problem

General Framework

Recall that the goal of our method is to take a collection of features identified in a set of experiments and partition the collection into sets of features representing the same object. The method of Section 2 does not directly accomplish this goal. How close the set of cliques is to the final solution depends on the nature of the data and the error bounds.

Recall that ε represents the set of experiments Eₖ, and that each Eₖεε is a set of features. Let F denote the set of features across all experiments; that is, F=∪ₖ₌₁^{K}Eₖ.

Furthermore, the method is are only concerned with “true” features f such that π(f)≠Ø. This subset of F is denoted as F_{π}. An identity relationship partitions F_{π} into equivalence classes Π₁,Π₂, . . . ,Π_{R}. The method is interested in finding the partition that satisfies the relationship f₁, f₂εΠ, if and only if π(f₁)=π(f₂).

Since the features are anonymous, π(f) is a hidden variable. Assuming access to properties of the feature π′(f) and a function φ(f,f′) is constructed that approximates Pr[π(f)=π(f′)|(f),π′(f′)]. The function φ may rely on the same data used to derive the boxes, and/or may depend on other information. Given such a function, find a partition of π that maximizes

$$( {\prod }_{r = 1}^{R} {\prod }_{f , {f}^{′} ∈ {\prod }_{r}} φ ( f , {f}^{′} ) ) ( {\prod }_{r = 1}^{R} {\prod }_{f ∈ {\prod }_{r} , {f}^{′} ∉ {\prod }_{r}} ( 1 - φ ( f , {f}^{′} ) ) ) \qquad ( 1 )$$

φ may be expensive to determine, and the search space of all possible partitions is large. Both the search space and the number of times φ is evaluated by using constraints imposed by the set of maximal cliques C found by the method of the previous section are restricted.

Theorem 2. The partition Π of F_{π} which maximizes (1) satisfies the property that for all ΠᵣεΠ, Πᵣ⊂C for some maximal clique CεC.

Proof: Suppose that f,f′εΠᵣ. Then, by Axiom 1, the boxes corresponding to these features intersect; since this hold for all pairs of features in Πᵣ, the boxes derived from these features must form a clique in G(β). Since C is the set of all maximal cliques in G(β), the clique induced by Πᵣ must be a subset of one of these cliques.

Note that C is not a partition of F only because some features appear in more than one member of C; each feature is guaranteed to participate in at least one clique. Hence, it is possible to transform C into the optimal partition Π by performing a series of two operations:

Assignment: Any feature which appears in multiple cliques must be assigned to a single clique and removed from the others.

Partition: Under φ, some features may not be likely to be identical, despite being placed in the same clique. Hence, cliques may be partitioned.

A number of standard combinatorial optimization methods can be used to search for the optimal partition, beginning with C and using the operations above to generate potential solutions.

The Parsimony Restriction

Suppose that φ relies upon the same sensor data used to generate β. In that case, there is no reason to partition a clique, since the sensor data indicates that the members may be identical and there is no external reason to believe that they are not. This notion is captured in the Principle of Parsimony, also known as Occam's Razor:

Axiom 2 (Principle of Parsimony). One should not increase, beyond what is necessary, the number of entities required to explain anything.

Hence, in the situation that is impossible (or rare) to have information utilized by φ which contradicts the compatibility of features, the optimization method can ignore the Partition operation and focus on optimizing via Assignment, leading to more efficiency. In this case, it is only necessary to compute φ(f,f′) if f and f′ appear in the same clique, and at least one of them appears in multiple cliques.

Estimating the Error Bounds

The error function εⱼ for each sensor should be known a priori from knowledge of the sensor, internal calibration, and/or external calibration. However, this is not always the case for a variety of reasons. In cases where the functions are not known ahead of time or where we wish to confirm our prior knowledge, we can attempt to estimate them from the data. A heuristic according to an embodiment of the present disclosure is based on making some assumptions about the error bounds and the nature of what the box overlap graph “should” look like with a good choice of error bounds.

The following assumptions are made about the functions:
Each εⱼ is parameterized by a single numerical parameter θⱼ, θⱼ≧0. The application of the function under this parameter on feature f is denoted εⱼ(f[j],θⱼ), and let θ be the vector of θⱼ, 1≦j≦d.
The number of overlaps in F in dimension j induced by εⱼ increases monotonically with θⱼ. Furthermore, given an interval [εⱼ^{l}(f[j]),εⱼ^{r}(f[j])], assume that the θⱼ can be found such that εⱼ(f,θⱼ)=[εⱼ^{l}(f[j]),εⱼ^{r}(f[j])].

Furthermore assume that many objects are observed in all experiments. Hence, it can be expected that a good choice of θ would lead to a large number of cliques whose size is K, and that these cliques would usually be vertex-disjoint from the other cliques in the graph. If these assumptions are valid for a particular data set, then we can choose the vector θ that induces a set of boxes β and overlap graph G(β) where the number of connected components in G(β) that are complete subgraphs of size K is maximized.

Let Ω represent the universe of all possible choices of θ. Since θεR^{d}, Ω may initially appear to be infinite. However, since the metric depends on the finite number of possible configurations of G(β), Ω can be thought of as a finite set of vectors whose values induce the different configurations.

Let f and f′ be features, and let \hat{θ}(f,f′) be such that

$$\hat{θ} ( f , {f}^{′} ) = {min}_{{θ}_{j} \geq 0} ( {ɛ}_{j} ( f , {θ}_{j} ) ⋂ {ɛ}_{j} ( {f}^{′} , {θ}_{j} ) = ∅ ) .$$

In other words, \hat{θ}(f,f′) represents the smallest value of θⱼ such that f and f′ are compatible. Now consider features f″ and f′″. We say that \hat{θ}(f,f′)≦\hat{θ}(f″,f′″) if and only if \hat{θ}(f,f′)≦\hat{θ}(f″,f′″) for all j, 1≦j≦d. Note that this relationship implies that under parameters \hat{θ}(f″,f′″), f and f′ are also compatible.

Let \hat{Ω} be the set {\hat{θ}(f,f′): f,f′εF}. New define the ⊕ operator such that By θ⊕θ′ is a d-dimensional vector where element j, 1≦j≦d, is defined as max{θⱼ,θ′ⱼ}. Let Ω be the closure of \hat{Ω} under ⊕.

Theorem 3 Let β′ be the set of boxes derived from F by θ′ and G(β′) be the overlap graph derived from β′. There exists a θεΩ which derives a set of boxes β from F such that G(β) is isomorphic to G(β′).

Proof: It can be shown how to select θ to produce the isomorphism. Match the vertices derived from the same element of F under θ and θ′; such that is it only needed to show how to choose θεΩ to achieve the same edge structure.

Let \hat{Ω}′={\hat{θ}(f,f′):{f,f′}εG_{E}(β′)}, where G_{E} denotes the edge set of G. Define θ such that for all j, 1≦j≦d, θⱼ=max_{\hat{θ}ε\hat{Ω}′}\hat{θ}ⱼ. Clearly for all \hat{θ}ε\hat{Ω}′, \hat{θ}≦θ. This implies that for all eεG_{E}(β′),eεG_{E}(β).

Now suppose e=(f,f′) is an edge in G_{E}(β). Consider an arbitrary j, 1≦j≦d. For this j, \hat{θ}ⱼ(f,f′)≦θⱼ. By the way θ was chosen, this means that there was an edge E′=(f″,f′″) in G_{E}(β′) such that \hat{θ}ⱼ(f″,f′″)=θⱼ. Since e′ is in G(β′), it also follows that \hat{θ}ⱼ(f″,f′″_≦θⱼ′. Thus, \hat{θ}ⱼ(f,f′)≦θⱼ≦θⱼ′ for all j, and so eεG_{E}(β′).

A Simple Exact Method

Let θ* be a vector such that for all j, 1≦j≦d, θⱼ′=θⱼ for some θε\hat{Ω}. Let Ω*={θ*} given \hat{Ω}.

Theorem 4. Ω⊂Ω*.

Proof. Let the set Dⱼ(Ω)={θⱼθεΩ}. In other words, Dⱼ is the set of all values appearing in dimension j of the vectors in Ω. Recall that Ω is the closure of \hat{Ω} under ⊕. It can be claimed that Dⱼ(Ω)=Dⱼ(\hat{Ω}). Let θεΩ−\hat{Ω}. Therefore θ=\hat{θ}⁽¹⁾⊕\hat{θ}⁽²⁾⊕ . . . \hat{θ}^{(M)}, where each \hat{θ}^{(m)}ε\hat{Ω}. However, this means that θⱼ is the result of successively taking the maximum of each θⱼ^{(m)} and θⱼ^{(m+1}), so therefore θⱼ=θⱼ^{(m)} for some m. Thus, θⱼ=Dⱼ. Since Ω* can equivalently be defined as D₁×D₂× . . . ×D_{d}, Ω⊂Ω*.

The enumeration of the elements of Ω* includes constructing the set Dⱼ for each dimension j and using loops to enumerate the elements of Ω*=D₁×D₂× . . . ×D_{d}. For each θⱼ, construct the corresponding β and G(β) and find the complete connected components of G(β).

The enumeration process can be accelerated by noting that if θ≦θ′ and G(β) and G(β′) are the respective graphs induced by θ and θ′, then G_{E}(β)⊂G_{E}(β′). The standard UNION-FIND data structure can be used to identify the connected components of G(β) as edges are added by values of θ in increasing order under the ≦ relation, Finding an optimal decomposition of Ω* into increasing sequences of parameters is an interesting problem; a simple (but sub-optimal) solution is to sort the Dⱼ sets prior to iteration, thereby forming runs of increasing subsequences.

A Faster Heuristic Method

Since the size of Ω* is O(n^{2d}), a faster heuristic method is needed for most applications. The steepest descent method in which the state θ has successors {θ′|θ≦θ′} 1X) is recommended here. This makes state transitions efficient by using the UNION-FIND data structure to quickly update the optimization criterion. Various heuristics might he used to choose the initial state, including states suggested by prior knowledge or expectation, or states determined by the distributions of the values in the Dⱼ, sets. It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

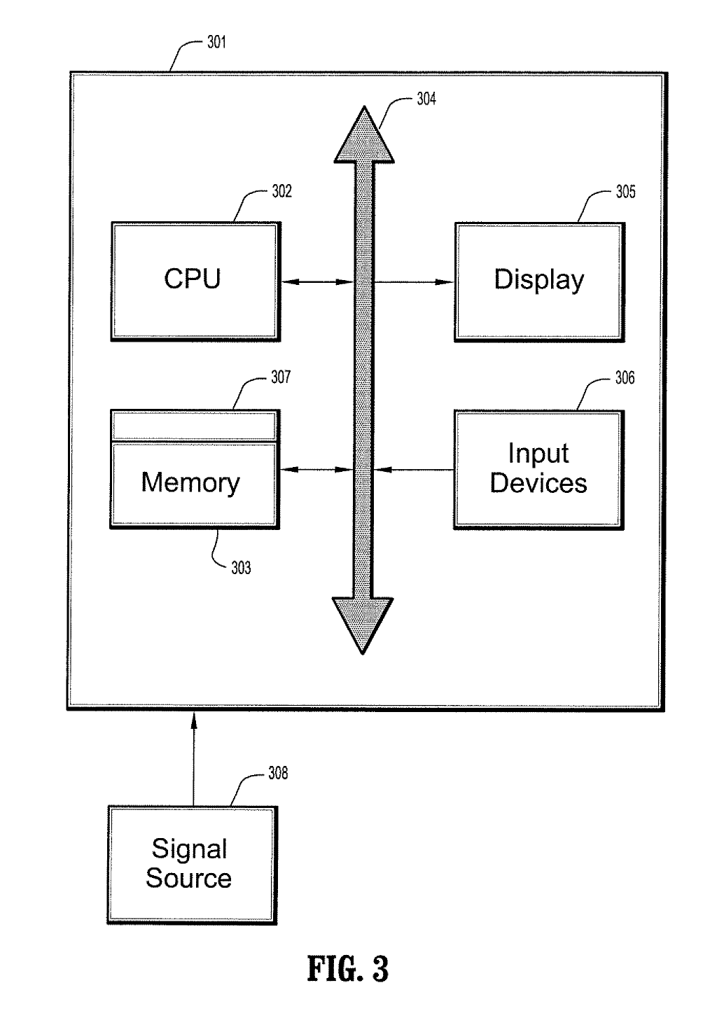

Referring to FIG. 3, according to an embodiment of the present disclosure, a computer system 301 for registering objects can comprise, inter alia, a central processing unit (CPU) 302, a memory 303 and an input/output (I/O) interface 304. The computer system 301 is generally coupled through the I/O interface 304 to a display 305 and various input devices 306 such as a mouse and keyboard. The support circuits can include circuits such as cache, power supplies, clock circuits, and a communications bus. The memory 303 can include random access memory (RAM), read only memory (ROM), disk drive, tape drive, etc., or a combination thereof. The present invention can be implemented as a routine 307 that is stored in memory 303 and executed by the CPU 302 to process the signal from the signal source 308. As such, the computer system 301 is a general-purpose computer system that becomes a specific purpose computer system when executing the routine 307 of the present invention.

The computer platform 301 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present disclosure provided herein, one of ordinary skill in the related art will be able to contemplate these and similar implementations or configurations.

Having described embodiments for a system and method for registering objects, it is noted that modifications and variations can be made by persons skilled in the art in light of the above teachings. It is therefore to he understood that changes may be made in embodiments of the present disclosure that are within the scope and spirit thereof.

What is claimed is:

1. A computer-implemented method for registering objects of interest across a plurality of data acquisition types comprising:
providing image data including the objects of interest corresponding to the plurality of data acquisition types;
providing a plurality of constraints on groups which may be determined for the objects of interest;
determining a set of possible groupings of the objects of interest according to the plurality of constraints;
searching the set of possible groupings for groupings of the objects of interest according to an optimization function; and
storing the groupings of the objects of interest to a computer-readable media.

2. The computer-implemented method of claim 1, wherein the plurality of constraints are error bounds on sensor data corresponding to a detection of each of the objects of interest.

3. The computer-implemented method of claim 2, wherein determining the set of possible groupings of the objects of interest is performed according to a bounded error model of the error bounds corresponding to the objects of interest.

4. The computer-implemented method of claim 1, wherein searching determines which grouping from the set of possible groupings best satisfies the optimization function.

5. The computer-implemented method of claim 1, further comprising wherein providing the plurality of constraints on groups comprises:
converting a plurality of features of the image into boxes in d-dimensional space,
wherein d is greater than 2, and
wherein the plurality of constraints are implemented as a box for each feature, the to box representing error bounds on sensor data corresponding to a detection of the features.

6. The computer-implemented method of claim 5, wherein determining the set of possible groupings of the objects of interest according to the plurality of constraints comprises determining a set of mutually-intersecting boxes.

7. A computer-implemented method for registering objects of interest across a plurality of data acquisition types comprising:
inputting image data including features, the image data including inputs corresponding to the plurality of data acquisition types;
providing a plurality of constraints on groups which may be determined for the features;
determining a set of possible groupings of the features according to the plurality of constraints;
searching the set of possible groupings for groupings of objects of interest according to an optimization function, wherein the set of possible groupings includes groupings of the objects of interest and groupings of features that do not correspond to the objects of interest; and
storing the groupings of the objects of interest to a computer-readable media.

8. The computer-implemented method of claim 7, wherein providing the plurality of constraints on groups comprises converting the features into boxes in d-dimensional space,
wherein d is greater than 2, and
wherein the plurality of constraints are implemented as a box for each feature, the box representing error bounds on sensor data corresponding to a detection of the features.

9. The computer-implemented method of claim 8, wherein determining the set of possible groupings of the features is performed according to a set of mutually-intersecting boxes of the features.

10. The computer-implemented method of claim 7, wherein searching determines and removes groupings violating transitivity.

11. A program storage device readable by machine, tangibly embodying a program of instructions executable by the machine to perform method steps for registering objects of interest across a plurality of data acquisition types, the method steps comprising.
providing image data including the objects of interest corresponding to the plurality of data acquisition types;
providing a plurality of constraints on groups which may be determined for the objects of interest;
determining a set of possible groupings of the objects of interest according to the plurality of constraints;
searching the set of possible groupings for groupings of the objects of interest according to an optimization function; and
storing the groupings of the objects of interest to a computer-readable media.

12. The method of claim 11, wherein the plurality of constraints are error bounds on sensor data corresponding to a detection of each of the objects of interest.

13. The method of claim 12, wherein determining the set of possible groupings of the objects of interest is performed according to a bounded error model of the error bounds corresponding to the objects of interest.

14. The method of claim 11, wherein searching determines which grouping from the set of possible groupings best satisfies the optimization function.

15. The method of claim 11, further comprising wherein providing the plurality of constraints on groups comprises:
converting a plurality of features of the image into boxes in d-dimensional space,
wherein d is greater than 2, and
wherein the plurality of constraints are implemented as a box for each feature, the box representing error bounds on sensor data corresponding to a detection of the features.

16. The method of claim 15, wherein determining the set of possible groupings of the objects of interest according to the plurality of constraints comprises
determining a set of mutually-intersecting boxes.
